(19) United States
(12) Patent Application Publication
(10) Pub. No.: US 2019/0143611 A1
(43) Pub. Date: May 16, 2019

(54) Laminated Moulded Parts and Manufacture Thereof

(71) Applicant: GURIT (UK) LTD., Hampshire (GB)

(72) Inventor: Daniel Thomas Jones, Isle of Wright (GB)

(21) Appl. No.: 15/999,590

(22) PCT Filed: Feb. 20, 2017
(86) PCT No.: PCT/EP2017/053802

§ 371 Date: Aug. 17, 2018

(30) Foreign Application Priority Data
Feb. 19, 2016 (GB) 1602951.4

(51) Int. Cl. B29C 70/08; B29C 70/34

(52) U.S. Cl. CPC B29C 70/081; B29C 70/345

(57) ABSTRACT

A method of moulding a moulding material to form a laminated moulded part of fibre-reinforced resin matrix composite material, the method comprising the steps of:
i. providing in a mould tool a preform comprising a central layer portion and a peripheral edge portion around at least a part of a periphery of the central layer portion, the central layer portion including at least one fibrous layer and a first resin, and the edge portion comprising a second resin including a plurality of individual fibres dispersed therein;
ii. closing the mould tool to define a closed mould cavity containing the moulding material; and
iii. applying heat and pressure to the mould cavity to cause the first and second resins to flow and to configure the moulding material in a fully moulded shape to form a laminated moulded part from the moulding material, wherein at least the first resin impregnates the at least one fibrous layer to form a central laminated portion of the laminated moulded part and wherein the second resin and the plurality of individual fibres dispersed therein flow to form a moulded edge of the laminated moulded part.

### FIELD OF THE INVENTION

The present invention relates to a method of moulding a moulding material to form a laminated moulded part of fibre-reinforced resin matrix composite material, and to a laminated moulded part of fibre-reinforced resin matrix composite material. In particular, the present invention relates to such a method which is for manufacturing moulded parts composed of fibre reinforced resin matrix composite materials, such as, for example, panels, more particularly automotive body panels, having a high quality surface finish.

### BACKGROUND

It is known to produce moulded parts for various applications, and having various shapes and configurations, by moulding materials including polymer resins, in particular for the manufacture of moulded parts composed of fibre reinforced resin matrix composite materials. Such composite materials are typically manufactured from moulding materials which may typically comprise, for example, (a) the combination of dry fibres and liquid resin, (b) prepregs and/or (c) sheet moulding compounds (SMC). Other materials may also be present, such as sandwich core materials and surfacing layers for forming a desired surface finish on the moulded part.

Many products are moulded by a manual process of laying-up the moulding material into a one sided mould, which moulds a single side of the resultant moulded article. Other products require a two-sided moulding process. In order to provide high manufacturing tolerance to the two-sided moulded part, it is sometimes required to use a press-moulding process in which the moulding material is moulded in a closed mould under elevated pressure.

A particular problem encountered with press moulding of an initial charge, or preform, of moulding material which at least partially comprises prepreg and/or SMC components, is that due to manufacturing tolerances in the initial charge the volume of the mould cavity is not always equal to the volume of the initial charge. Consequently, it is difficult to control the moulding process, especially to produce a composite material part having a moulded shape and dimensions which, on exit from the mould, have very close tolerance to the desired final shape and dimensions of the ultimately manufactured part, i.e. a “net shape moulded part”.

This problem is particularly acute when the moulded part has fine edge details, not only because fine shape and dimensions need to be accurately moulded but also because exposed edges of the composite material must be sealed with resin, so that the fibres are not exposed, in order to avoid cosmetic or structural defects occurring during subsequent manufacturing steps or during use of the moulded part.

Currently, using known composite material moulding technology, it is difficult to produce a press-moulded net shape moulded part from a composite material which does not require to be machined, trimmed or re-worked after moulding.

Autoclave processing has historically been used to produce composite material parts having a high quality “cosmetic” surface finish. Autoclave processing has been used for the manufacture of these parts, in preference to vacuum bag curing, because the higher autoclave pressure during resin impregnation and curing reduces the tendency for resin voids and pin-hole defects in the surface, resulting in a poor finish in the final painted components. VARTM/RTM type processes are less preferred due to the tendency to distort fabrics during lay-up and the resin injection disturbing and distorting the fibre which can read through to, or be witnessed in, the final finish.

It is accordingly an aim of this invention to provide a method of press moulding which at least partially overcome at least some of these significant disadvantages of the known press moulding materials and methods currently used to manufacture moulded parts of fibre reinforced resin matrix composite material, in particular which manufacture such parts using prepregs.

### SUMMARY OF THE INVENTION

The present invention provides a method of moulding a moulding material to form a laminated moulded part of fibre-reinforced resin matrix composite material, the method comprising the steps of:

i. providing in a mould tool a moulding material comprising a central layer portion and a peripheral edge portion around at least a part of a periphery of the central layer portion, the central layer portion including at least one fibrous layer and a first resin, and the edge portion comprising a second resin including a plurality of individual fibres dispersed therein;

ii. closing the mould tool to define a closed mould cavity containing the moulding material; and

iii. applying heat and pressure to the mould cavity to configure the moulding material in a fully moulded shape to form a laminated moulded part from the moulding material, wherein a central laminated portion of the laminated moulded part is formed from at least the first resin and the at least one fibrous layer arid a moulded edge of the laminated moulded part is formed from at least the second resin and the plurality of individual fibres dispersed therein, wherein the second resin and the plurality of individual fibres flow to form the moulded edge of the laminated moulded part.

The present invention also provides a moulded part, optionally being panel shaped, further optionally being an automotive body panel, produced by the method according to the present invention.

The present invention further provides a laminated moulded part of fibre-reinforced resin matrix composite material, the moulded part comprising a central laminated portion and a moulded edge around at least a part of a periphery of the central laminated portion, the central laminated portion including at least one fibrous layer impregnated by a first resin, and the moulded edge comprising a second resin including a plurality of individual fibres dispersed therein.

Preferred features of the present invention are defined in the respective dependent claims.

In accordance with the preferred embodiments of the present invention, the main structural fibrous laminate does not flow and fill the peripheral edge during the press moulding because the fibres therein are selected to be either long or entangled or both so that the fibrous material is restrained and stays in place in the mould tool during resin flow and consolidation in the press moulding step. This restraining of the main structural fibrous laminate in the mould tool can provide the desired mechanical properties of the resultant composite material moulded part and/or can provide that the resin therein tends not to flow and wash during the moulding step, which otherwise could result in an undesired distorted final surface, for example an unacceptably poor A-surface, for the moulded part. Moreover, the edge material is selected to flow and fill the peripheral edge detail. A key technical effect of the flow of the fibre-containing edge material is to raise and maintain hydraulic pressure and prevent excessive resin bleed during the moulding step, and this results from the flowing fibres coalescing to block or clog any gap in the mould tool adjacent to the peripheral edge. High hydraulic pressure in the mould cavity and low resin bleed from the mould cavity at a separation line between mould parts is key to achieving high quality of the moulded part, particularly at the peripheral edge thereof.

Accordingly, the present invention provides a method which is particularly suitable for manufacturing parts composed of fibre reinforced resin matrix composite materials, such as, for example, panels, more particularly automotive body panels which are fully impregnated and require no or limited subsequent trimming, machining or rework operations.

In particular, the preferred embodiments of the present invention can manufacture a moulded part which can exhibit a high quality aesthetic finish in which the fibres, in particular carbon fibres, are visible in the final moulded surface, for example what is referred to herein as a “cosmetic carbon” moulded product. Some applications, for example in the automotive industry, require the carbon fabric to be visible in the final product to emphasise the high technology nature of the product. It is important that the cosmetic carbon product has a high quality surface finish on all surfaces, including edges, which are visible in use.

The preferred embodiments of the present invention can provide the assembly of a net shaped preform in a mould, and then the preform is transferred to a press mould for press moulding. The use of press moulding allows a faster cure for the thermosetting resin than conventional autoclave processing which is used for the manufacture of composite material parts having a high quality surface finish as the press can be kept hot at the required cure temperature whereas in autoclave processing the tool is cycled between a relatively cool lay-up and a relatively hot cure temperature.

The preferred embodiments of the present invention can provide a net shaped preform which, after press moulding, exhibits in the final moulded part a high quality A-surface, and also a high quality B-surface. The moulded part has a smoothly rounded, beaded edge that just needs de-flashing (rather than machining) before coating with a clear lacquer finish coat.

The preferred embodiments of the present invention can enable the use of simple press mould tooling with a bulb feature to give a beaded edge feature without the need to have sliding tool parts to de-mould the component. This gives the advantage of a sealed and cosmetic pleasing edge which is safe to handle, and has enhanced stiffness and strength. The sealed moulded edge reduces moisture ingress into the laminate as compared to a machined edge, and that sealing can reduce the risk of delaminating the lacquer coating applied to the moulded part to finish the component.

The provision of a net-shaped preform with a beaded edge which is then press moulded improves the surface properties, particularly at the “A-surface” which is, in use, the front face of the moulded part.

The press moulding method of the invention may be employed to produce high volume, lightweight, low cost automotive body panels composed of composite material, and such production may incur minimal labour costs as a result of reducing or avoiding post-moulding finishing costs since the resin flash is minimised or eliminated and the part is accurately moulded.

The resin composition may be selected to have a high degree of cross-linking, so as to have a high glass transition temperature Tg, with the result that the moulded part is able to be conveyed along a high temperature paint line without distortion or surface damage to maintain what is categorised for automotive body panels by those skilled in the art as a “class A” surface finish.

### BRIEF DESCRIPTION OF THE DRAWINGS

Embodiments of the present invention will now be described by way of example only, with reference to the accompanying drawings, in which:

FIG. 1 schematically illustrates a cross section through a part of a mould tool, in an open configuration during a loading or unloading operation, for use in a press moulding method for moulding a moulding material in accordance with a first embodiment of the present invention;

FIG. 2 schematically illustrates a cross section through a part of the mould tool of FIG. 1 in a closed configuration during the moulding operation;

FIG. 3 is an enlargement of part of the mould tool of FIGS. 1 and 2 showing a final moulded part relative to the mould parts and mould cavity;

FIG. 4 schematically illustrates a cross section through a moulding material in accordance with a first embodiment of the present invention;

FIG. 5 schematically illustrates a cross section through a moulding material in accordance with a second embodiment of the present invention;

FIG. 6 schematically illustrates a cross section through a moulding material in accordance with a third embodiment of the present invention;

FIG. 7 schematically illustrates a cross section through a moulding material in accordance with a fourth embodiment of the present invention;

FIG. 8 is a micrograph showing a cross section through the edge of a press moulded part produced in accordance with an Example of the present invention using a moulding material in accordance with the first embodiment of the present invention;

FIG. 9 is an annotated micrograph showing different regions in a cross section through the edge of a press moulded part produced in accordance with an Example of the present invention using a moulding material in accordance with the first embodiment of the present invention;

FIG. 10 schematically illustrates a cross section through a moulding material not in accordance with the present invention;

FIG. 11 is a micrograph showing a cross section through the edge of a press moulded part produced in accordance with a Comparative Example using a moulding material according to FIG. 10;

FIG. 12 is a micrograph showing a cross section through the edge of a press moulded part produced in accordance with a Comparative Example using a moulding material according to FIG. 10;

FIG. 13 schematically illustrates a cross section through a moulding material not in accordance with the present invention;

FIG. 14 is a micrograph showing a cross section through the edge of a press moulded part produced in accordance with a Comparative Example using a moulding material according to FIG. 13;

FIG. 15 shows a micrograph, in both annotated and unannotated form, showing different regions in a cross section through the edge of a press moulded part produced in accordance with an Example of the present invention using a moulding material in accordance with a fifth embodiment of the present invention; and

FIG. 16 is a micrograph showing a cross section through the edge of a press moulded part produced in accordance with a Comparative Example.

### DETAILED DESCRIPTION

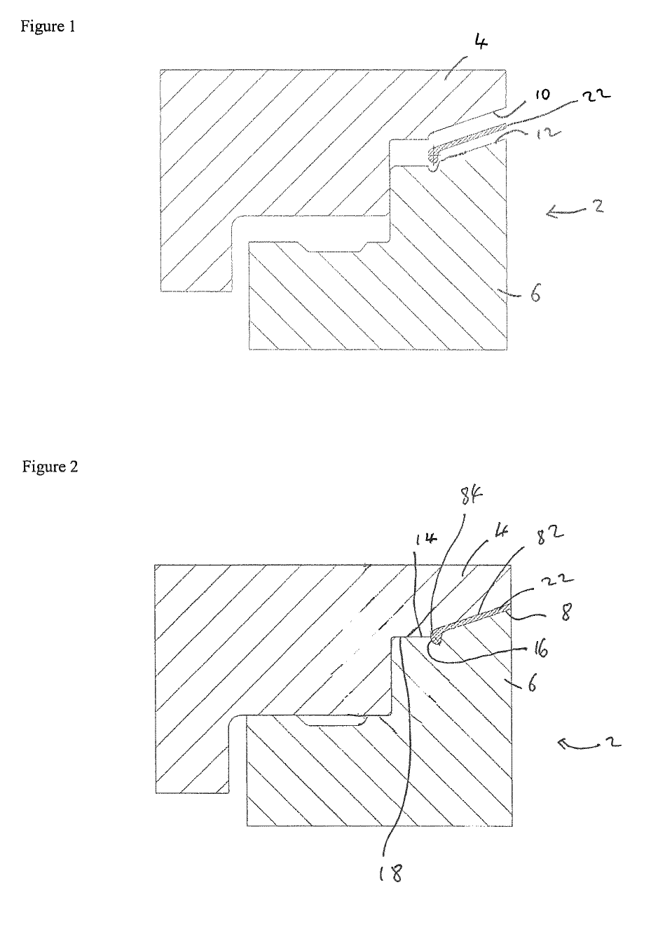

Referring to FIGS. 1 to 3 there is shown in schematic form a method of moulding a moulding material to form a laminated moulded part of fibre-reinforced resin matrix composite material in accordance with an embodiment of the present invention.

A mould tool 2 adapted for press moulding comprises first and second mould parts 4, 6 which are movable relatively to each other, for example by motion of the upper mould part 4 relative to the lower mould part 6, to define moulding material-loading or moulded part-unloading configuration as illustrated in FIG. 1 when the upper and lower mould parts 4, 6 are mutually separated and a moulding configuration as illustrated in FIG. 2 when the upper and lower mould parts 4, 6 are mutually engaged and at least partly define a mould cavity 8 therebetween. The mould tool 2 has a moulding surface with a three-dimensional shape, and in particular defines a panel shape, on that the moulded part formed by the mould tool 2 in the mould cavity 8 is in the form of a laminated panel, optionally an automotive body panel.

The upper and lower mould parts 4, 6 respectively provide upper and lower moulding surfaces 10, 12 for moulding the laminated moulded part. In the moulding configuration, there is an interface 14 between the upper and lower mould parts 4, 6 which intersects the peripheral part 16 of the mould cavity 8 when the upper and lower mould parts 4, 6 are in the moulding configuration, the interface being formed by a separation or split line 18 between the upper and lower mould parts 4, 6.

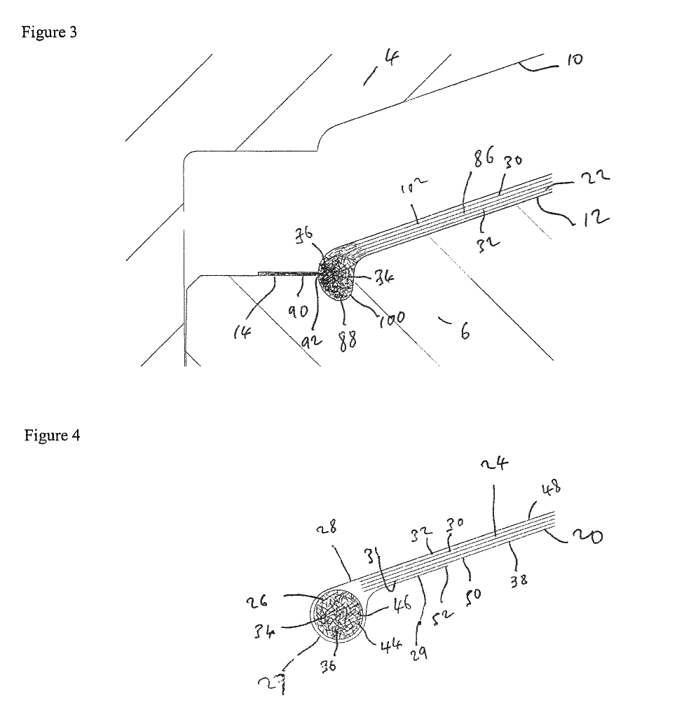

In the illustrated embodiment of the method of the present invention, and referring to FIG. 4, a moulding material 20 is provided in the mould tool 2. As shown schematically in FIGS. 3 and 4, the moulding material 20 of FIG. 4 is moulded to form a laminated moulded part 22 of fibre-reinforced resin matrix composite material as shown in FIG. 3.

The moulding material 20 comprises a central layer portion 24 and a peripheral edge portion 26 around at least a part of a periphery 28 of the central layer portion 24. The central layer portion 24 includes at least one fibrous layer 30 and a first resin 32. The edge portion 26 comprises a second resin 34 including a plurality of individual fibres 36 dispersed therein. Typically, the second resin 34 and the plurality of individual fibres 36 dispersed therein comprises a dough moulding composition.

As described hereinbelow, the central layer portion 24 preferably has long structural fibres 38 which are substantially fixed in position during a moulding process whereas the edge portion 26 has short fibres 36 which can flow during the moulding process.

The central layer portion 24 typically comprises at least one prepreg layer, the or each prepreg layer comprising a layer of fibres 30 at least partly impregnated by a solid or B-staged resin 32. Optionally the layer of fibres 30 is fully impregnated by the solid or B-staged resin 32. In some embodiments, at least one prepreg layer, preferably all of the prepreg layers, comprise a prepreg ply which comprises a unidirectional carbon fibre fully impregnated with thermosetting resin, typically an epoxy resin. In other embodiments, at least one prepreg layer, preferably all of the prepreg layers, comprise a prepreg ply which comprises a carbon fibre multi-axial stitched fabric, woven fabric, or non-woven fabric only partly impregnated on one surface thereof, to form a “single-sided prepreg”, with thermosetting resin, typically an epoxy resin. The fabric is selected to provide low distortion of the fibres during manufacture so that in the final moulded surface there is a high quality aesthetic finish provided by the fibres of the fabric, particularly when the moulded A-surface comprises carbon fibres.

Preferably the central layer potion 24 is formed from fibres greater than 25 mm in length and more preferably greater than 50 mm in length. Preferably the central layer potion 24 is formed from layers of fibres that can compact to give fibre volume fractions in excess of 30% and more preferably greater than 40% at moulding pressures below 50 bar which is advantageous to increase the specific properties of the panel to save weight.

Alternatively, in other embodiments, which are not illustrated, the central layer portion 24 comprises at least one layer 30 of fibres and a body of liquid resin adjacent to or at least partly impregnating the at least one layer of fibres 30.

Preferably the central layer portion has been preformed to have a shape which is close to the shape of the final moulded part so that in the final moulding step there is minimal resin and fibre movement to avoid distorting the fibre material and causing the formation of areas of different resin and fibre concentrations that can cause witness marks in the final painted surface.

The at least one fibrous layer 30 of the central layer portion 24 is typically in the form of collimated fibres, to form a unidirectional fibre layer, or a fabric, for example a multi-axial stitched fabric, a woven fabric or a non-woven fabric. The central layer portion 24 may comprise a stack of fibrous layers 30, as shown in FIG. 3. The layers may be orientated at different angles to each other to give the desired laminate properties.

The fibres 38 may be composed of carbon and/or glass, and any fibrous layer 30 may be unidirectional, biaxial or multiaxial. A variety of suitable carbon or glass fibre material or fabrics is well known to the person skilled in the art.

In contrast, in the edge portion 26 typically at least 50%, optionally at least 90%, by number of the fibres are short fibres 36. Such short fibres 36 preferably have a length of up to 50 mm, optionally from 0.5 to 10 mm, further optionally from 0.5 to 6 mm, still further optionally from 0.5 to 2 mm, yet further optionally from 0.75 to 1.25 mm. The short fibres 36 may be composed of carbon fibres, glass fibres or a mixture of carbon fibres and glass fibres. Typically, the central layer portion 24 and the edge portion 26 have the same composition of the fibres respectively included therein, for example carbon or glass fibres.

Typically, at least 3% by volume of the edge portion 26 comprises the short fibres 36. Optionally from 3 to 50% by volume, further optionally from 3 to 30% by volume, yet further optionally from 3 to 15% by volume of the edge portion 26 comprises the short fibres 36. The short fibres 36 are preferably substantially non-uniformly distributed, optionally randomly distributed, in the second resin 34 within the moulding material 20.

With regard to the first and second resins 32, 34, in the preferred embodiments of the present invention the first and second resins 32, 34 are both thermosetting resins which are co-curable. Typically the first and second resins 32, 34 are epoxy resins or vinyl ester resins, and for example have the same epoxy resin constituent(s) or vinyl ester resin constituent(s).

Preferably, the first and second resins 32, 34, when cured, have a respective Tg within +/−10° C. of each other.

Preferably, the respective fibrous and resin compositions of the central layer portion 24 and the peripheral edge portion 26 are controlled to provide that the central laminated portion and moulded edge of the laminated moulded part have substantially the same thermal expansion coefficient, optionally wherein a difference in the respective thermal expansion coefficients of the central laminated portion and the moulded edge is less than 20×10⁻⁶ mm/mmK.

The first and second resins 32, 34 may independently or each comprise at least one particulate filler material, optionally an inorganic filler material, further optionally an inorganic filler material in an amount of from 10 to 40 wt % based on the total weight of the respective resin. Typically, the particulate filler material is selected from talc or wollastonite or any mixture thereof. Preferably, the at least the respective surfaces of the first and second resins 32, 34 have substantially the same concentration of particulate filler material, optionally the respective concentrations of particulate filler material being within +/−10 wt % of each other.

The first and second resins 32, 34 may independently or each comprise a pigment, optionally substantially the same concentration of pigment, further optionally the respective concentrations of pigment being within +/−10 wt % of each other.

The edge portion 26 comprises at least one elongate resin strip 44 comprising the second resin 34 including the plurality of individual short fibres 36 dispersed therein. The strip 44 typically has a length of at least 500 mm, for example from 500 mm to 2 m, typically about 1 m, and a width of from 5 to 25 mm.

In the embodiment of FIG. 4, the elongate resin strip 44 is rolled into an elongate rod 46, optionally the rod 46 having a diameter of from 3 to 10 mm. At least one fibrous layer 30 in the central layer portion 24 extends into the peripheral edge portion 26. In this embodiment, an uppermost fibrous layer 30 in the central layer portion 24 at least partially, preferably fully, wraps around the peripheral edge portion 26, so as to extend between opposite upper and lower surfaces 48, 50 of the central layer portion 24, and a free end 52 of the uppermost fibrous layer 30 is wrapped around so as to be located at the lower surface 50 and inwardly relative to the peripheral edge portion 26. In this construction the peripheral edge portion 26 is retained in position by the wraparound uppermost fibrous layer 30. Since the uppermost fibrous layer 30 is folded back during the manufacturing process, at any corner of the peripheral edge portion 26 the uppermost fibrous layer 30 may be provided with one or more cuts or cut-outs at the corner to enable the folding back to be achieved with reduced, minimum or no overlap of the folded-back parts of the uppermost fibrous layer 30 in the vicinity of the corner.

This construction forms a substantially rounded rolled portion 27 surrounding the elongate rod 46 and a substantially flat folded-over portion 29 which is inward of the elongate rod 46. Typically, the uppermost fibrous layer 30 is folded over so that the folded-over portion 29 has a width of from 5 to 50 mm, optionally from 10 to 30 mm, further optionally from 15 to 25 mm, for example 20 mm. The folded-over portion 29 is preferably tacked to an outer surface of the lowermost ply 31. The width of the folded-over portion 29 is selected to ensure that it tacks down; a too short distance may not tack down but tends to lifts and a too long distance tends to be harder to fold back without distorting. The free end 52 is remote from the interface 14 of the subsequently used press moulding tool 2, otherwise it is possible that the fibres of the uppermost fibrous layer 30 may tend to migrate and distort during press moulding. The folded-over portion 29 is tacked to the outer surface of the lowermost ply 31 by the inherent tack of at least one or both of the plies. Alternatively, a tackifier may be applied to at least one of the plies. Optionally some heat and a roller pressure is used to consolidate the rolled, folded-over edge.

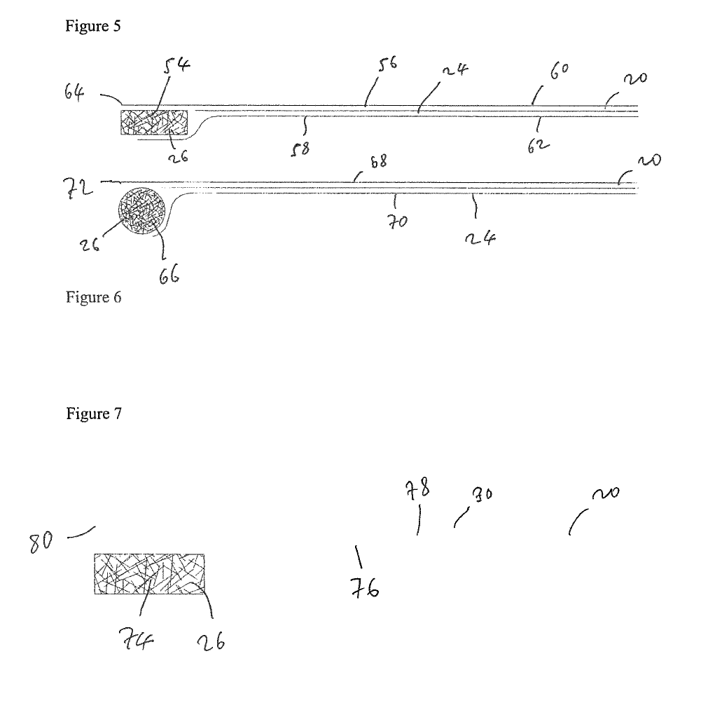

FIG. 5 schematically illustrates a cross section through a moulding material 20 in accordance with a second embodiment of the present invention. In the second embodiment of FIG. 5, the elongate resin strip 54 is substantially planar, having a substantially rectangular cross-section, and is partially wrapped by the fibrous layers. The uppermost and lowermost fibrous layers 56, 58 in the central layer portion 24 extend into the peripheral edge portion 26 and comprises upper and lower common fibrous layers 56, 58 at opposite respective surfaces 60, 62 of the central layer portion 24 and the peripheral edge portion 26, with the elongate resin strip 54 sandwiched therebetween. The uppermost fibrous layer 56 terminates at a free edge 64 of the peripheral edge portion 26. The lowermost fibrous layer 58 terminates at a distance, for example of from 1 to 10 mm, optionally from 1 to 5 mm, from the free edge 64 of the peripheral edge portion 26.

FIG. 6 schematically illustrates a cross section through a moulding material 20 in accordance with a third embodiment of the present invention which is a modification of the embodiment of FIG. 4 in that the elongate resin strip 66 is in the form of a rod rather than planar. The elongate resin strip 66 is partially wrapped by the uppermost and lowermost fibrous layers 68, 70, which are also in the central layer portion 24, with the elongate resin strip 66 sandwiched therebetween. The uppermost fibrous layer 68 terminates at a free edge 72 of the peripheral edge portion 26. The lowermost fibrous layer 70 terminates at a distance, for example of from 1 to 10 mm, optionally from 1 to 5 mm, from the free edge 72 of the peripheral edge portion 26.

FIG. 7 schematically illustrates a cross section through a moulding material 20 in accordance with a fourth embodiment of the present invention which is a modification of the embodiment of FIG. 4 in that the elongate resin strip 74 is planar but the elongate resin strip 74 is affixed on one surface, in the embodiment the lower surface 76, to the stack 78 of fibrous layers 30. The stack 78 terminates at a free edge 80 of the peripheral edge portion 26.

Prior to being provided in the mould tool 2, the moulding material 20 may be preformed, for example in an initial mould, to form a three-dimensionally shaped preform as the moulding material.

In one embodiment, the central layer portion 24 and the peripheral edge portion 26 of the moulding material 20 are assembled together to form the moulding material 20, which may be in the form of a preform, prior to providing the moulding material 20 in the mould tool 2.

When being provided in the mould tool 2, the central layer portion 24 may be draped onto the lower moulding surface 12 to assume a three-dimensional shape defined by the lower moulding surface 12.

As illustrated in FIGS. 1 to 4, the mould cavity 8 comprises a central part 82 which receives the central layer portion 24 of the moulding material 20 and a peripheral part 84 which receives the peripheral edge portion 26 of the moulding material 20. The volume of the peripheral edge portion 26 is greater, optionally at least 50% greater, further optionally at least 100% greater, than the volume of the peripheral part 84 of the mould cavity 8.

After the moulding material 20 has been provided on the lower moulding surface 12 of the mould tool 2, the mould tool 2 is closed to define the closed mould cavity 8 containing the moulding material 20.

Thereafter, heat and pressure are applied to the mould cavity 8 to configure the moulding material 20 in a fully moulded shape to form the laminated moulded part 22 from the moulding material 20. The moulding material 20 is press moulded to form the moulded part 22 as shown in FIG. 4.

As shown in FIGS. 1 to 4, a central laminated portion 86 of the laminated moulded part 22 is formed from at least the first resin 32 and the at least one fibrous layer 30, the at least one fibrous layer 30 being impregnated by the first resin 32, and a moulded edge 88 of the laminated moulded part 22 is formed from at least the second resin 34 and the plurality of individual fibres 36 dispersed therein. The first and second resins 32, 34 are cured during the moulding process as a result of the elevated temperature and pressure.

The at least one fibrous layer 30 is restrained within the mould cavity and the long fibres therein do not move substantially during the press moulding process. The long fibres are typically interconnected, for example in a woven fabric, or entangled, for example in a non-woven fabric, which retains the fibres in position during the exposure to elevated pressure and temperature during press moulding.

In contrast, the second resin 34 and the plurality of individual fibres 36 flow to form the moulded edge 88 of the laminated moulded part 22. An amount of the peripheral edge portion 26 of the moulding material 20 is squeezed outwardly from the mould cavity 8 into a gap 90 at the interface 14 between the first and second mould parts 4, 6. The fibres 36 in the peripheral edge portion 26 of the moulding material 20 flow towards the interface 14 and at least partially block an opening 92 at the interface 14 to restrict resin flow out of the mould cavity 8.

The resultant moulded edge 88 comprises an elongate body of the second resin 34 including the plurality of individual fibres 36 dispersed therein with a substantially non-uniform distribution in the second resin 34.

As illustrated in the drawings, the laminated moulded part 22 has a downwardly depending peripheral rim 100 surrounding a central moulded portion 102 which has a three-dimensional shape to define a panel shape. The upper moulding surface 10 is configured to define the “A-surface” which is, in use, the front face of the resultant moulded part 22. In the illustrated embodiment the panel has a substantially rectangular plan, but any regular, e.g. polygonal, or irregularly shaped moulded parts may be manufactured according to various different embodiments of the present invention. In addition, in an alternative embodiment, the lower moulding surface may be configured to define the “A-surface” and the upper moulding surface may be configured to define the “B-surface”. In a further alternative embodiment, both the upper and lower moulding surfaces may be configured to define respective “A-surfaces”.

The rim 100 is formed from the second resin 34 including the plurality of individual fibres 36 to form the smoothly curved moulded edge 88 of the moulded part. The individual fibres, together with any fabric ply which extends into the moulded edge 88 as described above for the various embodiments, form a reinforced bead at the peripheral edge of the laminated moulded part 22. In the illustrated embodiments the rim 100 is provided around the entire central moulded portion 102 to form a reinforced bead at the peripheral edge of the entire laminated moulded part. However, in other embodiments the reinforced bead surrounds only part of the laminated moulded part.

The individual fibres are is selected to have a coefficient of thermal expansion and modulus substantially the same as, for example within +/−10% of, the corresponding parameters for the fibrous reinforcement plies. Typically, the individual fibres comprise carbon fibres, although other high modulus, low thermal shrinkage fibres may be employed, such as glass fibres or heat set polymer, for example polyester, fibres.

In a press moulding step a moulding pressure, at elevated temperature, is applied to the mould cavity 8 to consolidate the moulding material 20 and to cause the resin to flow and fully impregnate the fibres, and to configure the moulding material 20 in the final moulded shape. Typically, the moulding step is carried out at an elevated temperature of at least 50° C. The selected temperature is dependent upon the selection of the specific curing temperature of the thermosetting resin.

The moulding material 20 disposed in the mould tool 2 has substantially the same dimensions, shape and configuration as the final laminated moulded part 22, apart from minor entry of resin into the opening at the interface, which is minimised as a result of the flowing individual fibres 36 blocking the opening at the interface to form minor resin flash. Consequently, the press moulding operation ensures full resin impregnation of the fibres and avoidance of voids in the resin, and also cures the thermosetting resin, but does not substantially modify the dimensions, shape and configuration of the moulding material when forming the final laminated moulded part. Therefore the moulding material is a “near net shape” preform. During press moulding there is minimum resin flash formed at the junction of the press mould tool halves. Whatever minimum resin flash is formed can readily be removed by snapping, cutting or sanding. Since the moulding material has substantially the final desired dimensions, shape and configuration as the final laminated moulded part, these dimensions, shape and configuration can readily be achieved during the prepreg layup assembly process in the assembly mould, thereby minimising post-moulding shaping or trimming of the final laminated moulded part.

The bead provides a highly aesthetic peripheral edge to the moulded part, which is particularly important when the moulded part is a vehicle body panel mounted so that the peripheral edge is visible. In addition, if the moulding material is assembled and optionally preformed prior to being disposed in the mould tool, the bead assists rigidification of the moulding material during transfer from the assembly/preform mould to the press mould tool.

The outer surface of the laminated moulded part is three-dimensionally shaped. At least a portion of, optionally the entire, peripheral edge of the laminated moulded part is formed from the dough moulding composition to form a smoothly curved edge of the moulded part. The dough moulding composition, and any optional fabric plies extending around or into the moulded edge, form a reinforced bead at the peripheral edge of the laminated moulded part.

In the preferred embodiments of the present invention, carbon fibre prepreg material is employed as the at least one fibrous layer in the central laminated part. However, in other embodiments other fibres may be employed, such as glass fibres. Furthermore, one or more additional plies may be provided in the assembly, either locally or throughout the entire moulded part. The resultant multilayer laminate is an engineered structure which is configured to achieve low weight and to avoid thermal warping as cools down from the moulding temperature. In some areas of the multilayer laminate optional additional reinforcements may be provided for localised strength. The fibre layers are selected to provide the desired mechanical properties to the resultant moulded part. For example, when the moulded part is intended to be an automotive body panel, the fibre layers have a low coefficient of thermal expansion and high tensile modulus.

The resin used in the moulding material is typically a curable thermosetting resin, such as an epoxy resin. The resin is preferably selected to have a composition to provide, when cured, a high glass transition temperature Tg, for example a Tg of at least 120° C., more preferably 150° C., or 200° C. This high temperature is selected so that the cured moulded part can be subjected to elevated temperatures, for example by passing a press moulded automotive body panel down a high temperature automotive body paint line, without degradation or warping of the panel.

During the moulding operation, the mould tool is closed to define the mould cavity and a vacuum applied to remove any trapped volatiles. The temperature of the moulding material increases and pressure is applied to consolidate the moulding material and cause the resin to flow throughout the entire mould cavity, wet the mould surfaces, and fully impregnate the fibrous material of the moulding material. The flowable fibre and optional filler within the edge material flows to fill the edge detail and also tries to exit the tool via the mould flash gaps. The fibre and optional filler clog in the flash gaps increasing the resistance for resin to pass out of the mould. This allows the hydraulic pressure of the resin to increase and be maintained during the consolidation and impregnation steps to ensure resin flow throughout the entire mould cavity, and ensure full and consistent resin impregnation, and minimise void formation. In contrast the fibres forming the main structural laminate formed of the central later portion 24 are restrained, for example by being elongate (as in a unidirectional layer) or by being entangled (as in a non-woven later) or by being stitched or woven, and do not have the same ability to flow and fill the edge detail or clog in the tooling flash gaps. As a result, in the absence of any edge material comprising flowable fibres a higher amount of resin would bleed out of the mould cavity and lower hydraulic pressure would occur, potentially resulting in a loss in part quality near to the perimeter.

After the press moulding operation has terminated and the resin has fully cured, the mould tool is opened, and the moulded part is demoulded from the mould tool.

The present invention is further illustrated with reference to the following non-limiting Examples.

### EXAMPLE 1

A cosmetic carbon fibre component having a stack as described below in Table 1 was provided to form a central layer portion of a moulding material.

TABLE 1

| Ply | Product Description | |
|---|---|---|
| 1 | SF-160 300 gsm | 300 gsm surfacing epoxy resin (160° C. Tg) |
| 2 + 3 | ST160/NMAT/HSC/100/60% | 100 gsm non-woven needled carbon fibre made |
| | | from recovered carbon fibre consisting of a |
| | | mixture of fibres between 10 and 150 mm in |
| | | length with 60 wt % epoxy resin (160° C. Tg) |
| | | content as a single-sided non-impregnated |
| | | prepreg |
| 4 | ST160/XC300C/51% | 300 gsm non crimp stitched biaxial carbon fibre |
| | | fabric with 51 wt % epoxy resin (160° C. Tg) |
| | | content as a single-sided non-impregnated |
| | | prepreg |
| 5 + 6 | ST160/NMAT/HSC/100/60% | 100 gsm non-woven needled carbon fibre made |
| | | from recovered carbon fibre consisting of a |
| | | mixture of fibres between 10 and 150 mm in |
| | | length with 60 wt % epoxy resin (160° C. Tg) |
| | | content as a single-sided non-impregnated |
| | | prepreg |
| 7 | SF-160 300 gsm | 300 gsm surfacing epoxy resin (160° C. Tg) |

An edge filler resin paste was prepared by dispersing 7 wt % (5 vol %) of 1 mm milled carbon fibre, 25 wt % of talc filler, 0.1 wt % of carbon black pigment paste, into 67.9 wt % of ST160 prepreg resin and hardener available from Gurit. The dispersion was prepared at 80° C. using a DAC centrifugal mixer. ST160 is an epoxy prepreg resin having a cured Tg of 160° C. and suitable for press moulding composite parts using a 15 minute hot-in/hot-out 150° C. cure cycle. The hot material was poured onto siliconised paper. A second siliconised paper was then applied and the mixture rolled into a 2 mm thick sheet using a set of mangle rollers. The material was allowed to cool back to room temperature (20-23° C.). The resulting material had a putty like consistency and could be cut and rolled into strips. The material has sufficient tack to lightly adhere to itself and other prepregs during a laminating process.

A press mould was provided having a mould cavity 1.2 m wide×1.1 m long in plan with a nominal mould cavity thickness of 1.27 mm. The mould tool had a 0.1 mm vertical gap between the mould parts at the interface therebetween. The lower mould to form the B-surface was heated to 150° C. and the upper mould to form the A-surface was heated to 155° C.

A strip of the edge filler resin paste ˜10 mm wide by ˜1 m long was cut and rolled into a ˜5 mm diameter rod. A rod was positioned around the perimeter edge of the moulding material to form the moulding material structure of FIG. 3. The uppermost ply to form the front surface of the moulded part was longer than the remaining plies to provide a 20 mm wide extension longer than the nominal tool dimension which was pushed into the tool edge. The remaining plies were 3 mm shorter than the nominal tool dimension. The extension was wrapped around the rod of the edge filler resin paste and then tacked onto the surface of the lowermost ply. This assembly formed a preform.

The preform was then located in the mould tool by being positioned on the lower mould.

The press mould was then closed and a hot-in/hot-out cure cycle was carried out. The mould was closed, and then the mould cavity was evacuated by application of a vacuum. When the upper mould was 5 mm above the preform the absolute pressure was less than 50 mBar and when the upper mould was 1.5 mm above the preform the absolute pressure was less than 30 mBar. The upper mould was then lowered at a speed of about 0.1 mm/s to cause slow impregnation of the fibrous layers at gradually increasing mould pressure up to a final mould pressure of 10 bar, which was achieved after a total time of about 65-90 seconds from application of the initial vacuum. The cure was completed over a total cycle period of up to 15 minutes, and then the mould was opened and the moulded part demoulded while still heated.

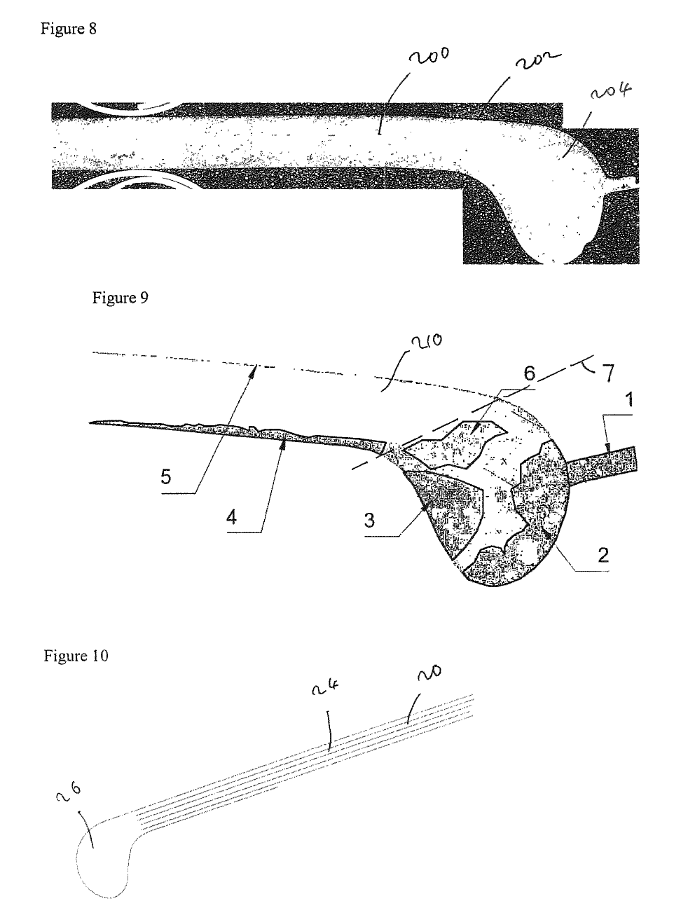

FIG. 8 is a micrograph showing a cross-section through the edge of a press moulded panel 200 produced in accordance with Example 1 using a moulding material of FIG. 4. The resultant panel had a good quality A-surface 202 and good quality edge detail. There was very little resin flash out of the tool. In the moulded edge 204, there is a concentration of short fibres and filler particles to reinforce the moulded edge 204. There is very low void content in the press moulded panel 200.

FIG. 9 is an annotated micrograph showing a cross-section through the edge of a press moulded panel 210 produced in accordance with Example 1 using a moulding material of FIG. 4 in which the edging paste initially comprised 5 vol % milled carbon fibres. Region 1 is the tool flash gap and comprised 34 vol % milled carbon fibres; Region 2 is located at the middle to bottom portions of the outer part of the moulded edge and comprised 23.7 vol % milled carbon fibres; Region 3 is located at the middle portion of the inner part of the moulded edge and comprised 26.1 vol % milled carbon fibres; Region 4 is along the B-surface from the moulded edge and comprised 33.7 vol % milled carbon fibres; Region 5 is along the A-surface from the moulded edge and comprised no milled carbon fibres; Region 6 is in a middle of the moulded edge adjacent to the central laminated part and comprised 6.4 vol % carbon fibres; and Region 7 is the entire moulded edge below the dotted line of FIG. 9 and comprised 14.4 vol % carbon fibres.

It may be seen from FIG. 9 that the edging paste flowed during moulding to provide a high concentration of short fibres which blocked the interface between the mould parts to minimise resin flash. Also, that flow phenomenon maintained a high resin pressure during moulding and curing to minimise the formation of voids.

A high quality net-shaped part which required minimal flash removal was formed.

### COMPARATIVE EXAMPLE 1

The same preform mould and cure process as in Example 1 were used but in combination with a modified moulding material having the structure and composition as shown in FIG. 10. In this Comparative Example, the central layer portion 24 of the moulding material 20 had substantially the same laminated construction as used for Example 1 but in the peripheral edge portion 26 no short carbon fibres were present. The peripheral edge portion 26 comprised epoxy resin, filler and pigment.

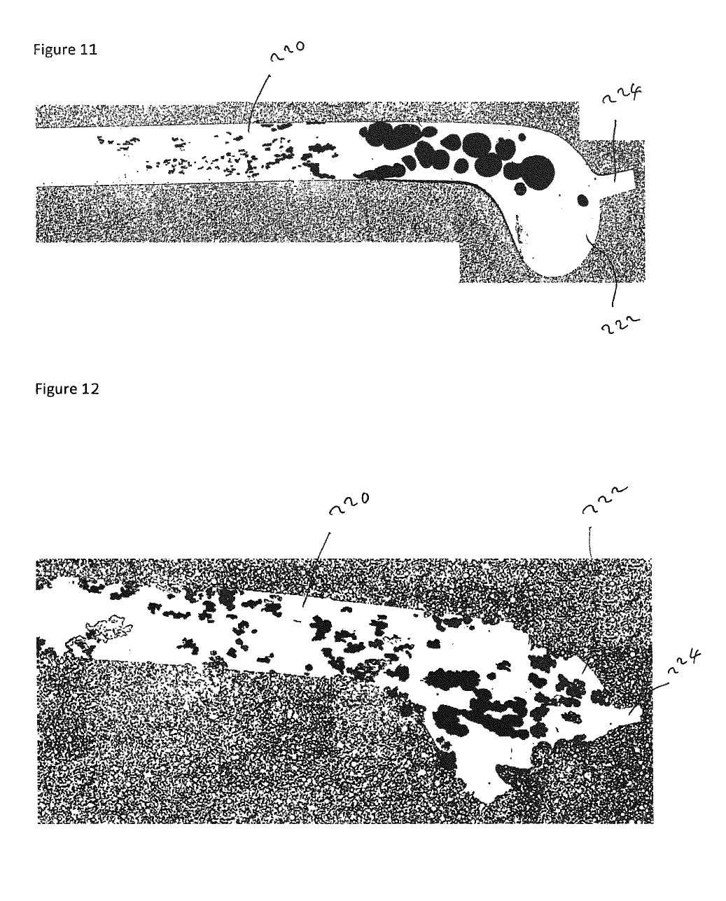

FIGS. 11 and 12 are respective micrographs showing a cross section through the edge of a press moulded part 220 produced in accordance with Comparative Example 1 using the moulding material 20 according to FIG. 10. It may be seen that the moulded edge 222 has an unacceptably high void content (shown by the black areas) in resin-rich zones. There was a high level of resin bleed out from the mould tool. The voiding was believed to be caused by loss of resin pressure due to the low fibre content in the moulded edge 22, giving a highly permeable edge and easy resin flow out of the moulding cavity. The outer surface of the moulded edge 222 was uneven, and missing in places. The resin flash 224 was high.

### COMPARATIVE EXAMPLE 2

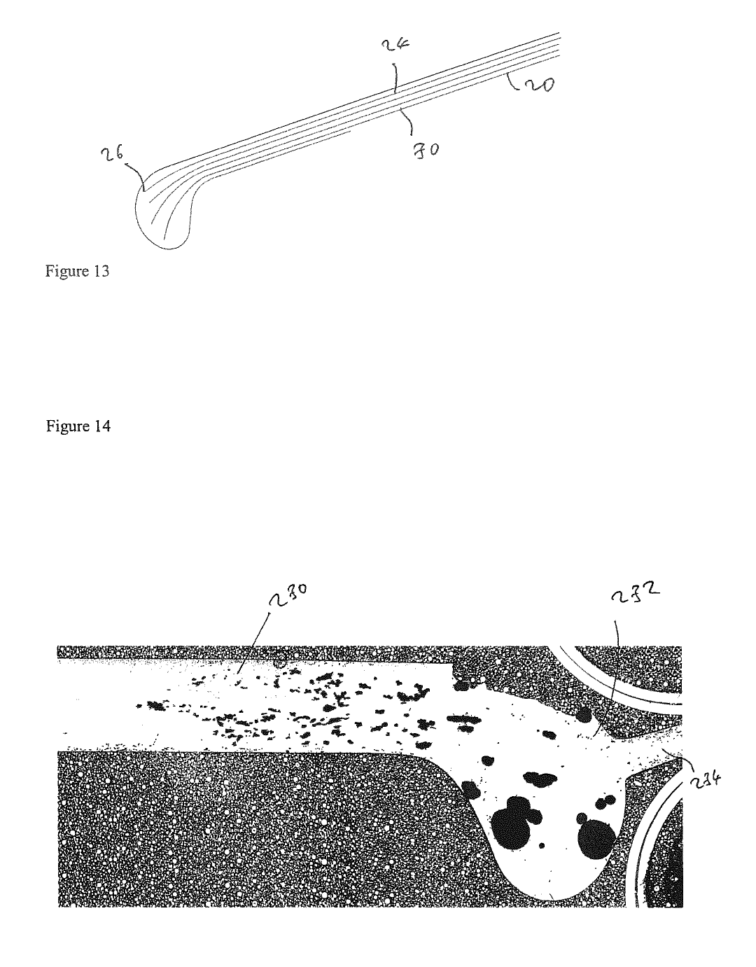

A test preform edge mould, and the cure process as in Example 1, were used but in combination with a modified moulding material having the structure and composition as shown in FIG. 13. In this Comparative Example, the central layer portion 24 of the moulding material 20 had substantially the same laminated construction as used for Example 1 but the carbon fabric plies 30 extended into the peripheral edge portion 26, in which no short carbon fibres were present. The peripheral edge portion 26 comprised epoxy resin, filler and pigment around the extended fabric plies 30.

FIG. 14 is a micrograph showing a cross section through the edge of a press moulded part 230 produced in accordance with Comparative Example 2 using the moulding material 20 according to FIG. 13. It may be seen that the moulded edge 232 has an unacceptably high void content (shown by the black areas) in resin-rich zones. There was a high level of resin bleed out from the mould tool, indicated by resin flash 234. There was unacceptably high resin towards the perimeter of the moulded part 230. The reinforcement fabric extending into the moulded edge caused unacceptable thickness variations in the moulded edge 232. The outer surface of the moulded edge 232 was uneven, and missing in places.

### EXAMPLE 2

A test preform edge mould, and the cure process as in Example 1, were used but in combination with a modified moulding material having the structure and composition as shown in FIG. 6. Glass fibre fabric was employed rather than carbon fibre fabric. In this Example, a flat panel 240 was moulded and the central layer portion of the moulding material had substantially the same laminated construction as used for Example 1. The uppermost and lowermost fabric plies partially wrapped around the peripheral edge portion which comprised a rod of the edging paste comprising the short carbon fibres. The central ply was cut 2 mm shorter to accommodate the edging paste. The peripheral edge portion comprised the same edging paste, comprising epoxy resin, short carbon fibres, filler and pigment, as in Example 1.

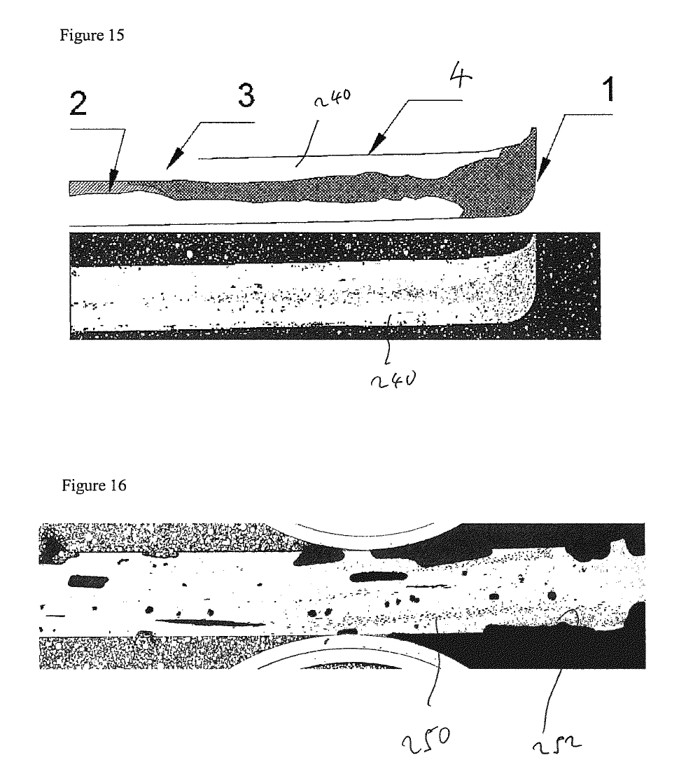

FIG. 15 shows a micrograph, in both annotated and unannotated form, showing different regions in a cross section through the edge of a press moulded part 240 produced in accordance with Example 2 using the moulding material according to FIG. 6.

The resultant panel 240 had a good quality A-surface and good quality edge detail. There was very little resin flash out of the tool. There is a concentration of short fibres and filler particles to reinforce the moulded edge. There is very low void content.

In the unannotated micrograph, the dark areas in the centre are mainly milled carbon fibres with a very occasional small void. On the bottom surface, the middle of the laminate has darker areas which are also occasional small voids. However, the void content is low.

In the annotated micrograph, Region 1 has a high concentration of the milled carbon fibres and filler particles extending to about 6 mm from the free edge; Region 2 has a low concentration of the milled carbon fibres and filler particles extending to about 12 mm from the free edge; Region 3 is the base laminate with minor voiding; and Region 4 shows pigment and filler extending to about 6 mm along the surface.

A high quality net-shaped part which required minimal flash removal was formed.

### COMPARATIVE EXAMPLE 3

In Comparative Example 3, Example 2 was repeated but with the modification that no edging paste was used and all the plies had the same length.

FIG. 16 shows a micrograph of a cross section through the edge of a press moulded part 250 produced in accordance with Comparative Example 3 using the moulding material according to FIG. 6 but without any short fibres in the rod of edging paste. In FIG. 16 the upper and lower circular segments show a holder for the press moulded part 250 when the micrograph was taken.

The resultant panel had a poor quality A- and B-surfaces and poor quality edge detail. There was surface pitting around the panel edge 252 and significant resin flash out of the tool. There is high void content in the bulk of the laminate. The laminate quality was worse closer to the perimeter indicating a loss of hydraulic pressure towards the edge of the laminate.

The preferred embodiments of the present invention can provide the press moulding of a multilayer moulding material which can deliver consistent press moulded composite parts at high material and manufacturing tolerances. This moulding material can enable net shape parts to be manufactured, thereby requiring less finishing work and permitting the use of simpler press and tooling designs.

The preferred embodiments of the present invention can provide the press moulding of a multilayer which enables a net shape moulding to be made with minimal resin flash issues during the press moulding process.

Various modifications to the illustrated embodiments of the invention will be readily apparent to those skilled in the art.

1. A method of moulding a moulding material to form a laminated moulded part of fibre-reinforced resin matrix composite material, the method comprising the steps of:
i. providing in a mould tool a moulding material comprising a central layer portion and a peripheral edge portion around at least a part of a periphery of the central layer portion, the central layer portion including at least one fibrous layer and a first resin, and the edge portion comprising a second resin including a plurality of individual fibres dispersed therein;
ii. closing the mould tool to define a closed mould cavity containing the moulding material, wherein the mould cavity comprises a central part which receives the central layer portion of the moulding material and a peripheral part which receives the peripheral edge portion of the moulding material, and the mould tool comprises first and second mould parts which at least partly define the mould cavity when the first and second mould parts are in a moulding configuration and which are mutually separated when the first and second mould parts are in a moulding material-loading or moulded part-unloading configuration, there being an interface between the first and second mould parts which intersects the peripheral part of the mould cavity; and
iii. applying heat and pressure to the mould cavity to configure the moulding material in a fully moulded shape to form a laminated moulded part from the moulding material, wherein a central laminated portion of the laminated moulded part is formed from at least the first resin and the at least one fibrous layer and a moulded edge of the laminated moulded part is formed from at least the second resin and the plurality of individual fibres dispersed therein, wherein the second resin and the plurality of individual fibres flow to form the moulded edge of the laminated moulded part, wherein during step iii the fibres in the peripheral edge portion of the moulding material flow towards the interface and at least partially block an opening at the interface to restrict resin flow out of the mould cavity.

2. A method according to claim 1 wherein at least 90%, by number of the fibres have a length of up to 50 mm, or from 0.5 to 10 mm.

3. A method according to claim 1 wherein from 3 to 50% by volume of the edge portion comprises the fibres.

4. A method according to claim 1 wherein the fibres are substantially non-uniformly distributed, or randomly distributed, in the second resin within the moulding material.

5. A method according to claim 1 wherein the fibres comprise carbon fibres, glass fibres or a mixture of carbon fibres and glass fibres.

6. A method according to claim 1 wherein the second resin further comprises at least one particulate filler material comprising an inorganic filler material in an amount of from 10 to 40 wt % based on the total weight of the edge portion.

7. A method according to claim 6 wherein the first resin further comprises at least one particulate filler material comprising an inorganic filler material in an amount of from 10 to 40 wt % based on the total weight of the first resin.

8. A method according to claim 7 wherein at least the respective surfaces of the first resin and the edge portion have substantially the same concentration of particulate filler material, wherein the respective concentrations of particulate filler material are within +/−10 wt % of each other.

9. A method according to claim 7 wherein the particulate filler material is selected from talc or wollastonite or any mixture thereof.

10. A method according to claim 1 wherein the first resin and the edge portion each comprise a pigment, the respective concentrations of pigment being within +/−10 wt % of each other.

11. A method according to claim 1 wherein the first and second resins are both thermosetting resins which are co-curable.

12. A method according to claim 11 wherein the first and second resins are epoxy resins or vinyl ester resins.

13. A method according to claim 12 wherein the first and second resins have the same epoxy resin constituent(s) or vinyl ester resin constituent(s).

14. A method according to claim 11 wherein the first and second resins, when cured, have a respective Tg within +/−10° C. of each other.

15. A method according to claim 1 wherein the edge portion comprises at least one elongate resin strip comprising the second resin including the plurality of individual fibres dispersed therein.

16. A method according to claim 15 wherein the at least one elongate resin strip has a length of at least 500 mm and a width of from 5 to 25 mm.

17. A method according to claim 15 wherein the at least one elongate resin strip is substantially planar or rolled into an elongate rod, the rod having a diameter of from 3 to 10 mm.

18. (canceled)

19. A method according to claim 18 wherein the volume of the peripheral edge portion of the moulding material is at least 50% greater than the volume of the peripheral part of the mould cavity, and during step iii an amount of the peripheral edge portion of the moulding material is squeezed outwardly from the mould cavity into a gap at the interface between the first and second mould parts.

20. (canceled)

21. A method according to claim 1 wherein the respective fibrous and resin compositions of the central layer portion of the moulding material and the peripheral edge portion of the moulding material are controlled to provide that the central laminated portion and moulded edge of the laminated moulded part have substantially the same thermal expansion coefficient, and wherein a difference in the respective thermal expansion coefficients of the central laminated portion and the moulded edge is less than 20×10⁻⁶ mm/mmK.

22. A method according to claim 1 wherein the second resin and the plurality of individual fibres dispersed therein comprises a dough moulding composition.

23. A method according to claim 1 wherein the central layer portion of the moulding material comprises at least one prepreg layer, the or each prepreg layer comprising a layer of fibres at least partly impregnated by a solid or B-staged resin.

24. A method according to claim 1 wherein the central layer portion of the moulding material comprises at least one layer of fibres and a body of liquid resin adjacent to or at least partly impregnating the at least one layer of fibres.

25. A method according to claim 1 wherein the moulding material is preformed to form a preform prior to providing the moulding material in the mould tool.

26. A method according to claim 25 wherein the central layer portion of the moulding material and the peripheral edge portion of the moulding material are assembled together to form the preform prior to providing the preform in the mould tool.

27. A method according to claim 1 wherein at least one fibrous layer in the central layer portion of the moulding material extends into the peripheral edge portion of the moulding material.

28. A method according to claim 27 wherein the at least one fibrous layer in the central layer portion of the moulding material which extends into the peripheral edge portion of the moulding material comprises a common fibrous layer at a surface of the central layer portion and the peripheral edge portion.

29. A method according to claim 28 wherein the at least one fibrous layer in the central layer portion of the moulding material which extends into the peripheral edge portion of the moulding material comprises first and second common fibrous layers at opposite respective surfaces of the central layer portion and the peripheral edge portion.

30. A method according to claim 28 wherein the at least one fibrous layer in the central layer portion of the moulding material which extends into the peripheral edge portion of the moulding material at least partially wraps around the peripheral edge portion.

31. A method according to claim 27 wherein the at least one fibrous layer in the central layer portion of the moulding material extends into the peripheral edge portion of the moulding material so as to terminate at a distance of from 1 to 10 mm from a free edge of the peripheral edge portion.

32. A method according to claim 27 wherein the at least one fibrous layer in the central layer portion of the moulding material extends into the peripheral edge portion of the moulding material so as to terminate at a free edge of the peripheral edge portion.

33. A method according to claim 1 wherein the at least one fibrous layer of the central layer portion is in the form of unidirectional fibres or a fabric, selected from a multi-axial stitched fabric, a woven fabric or a non-woven fabric.

34. A method according to claim 1 wherein fibres in the at least one fibrous layer of the central layer portion are restrained from flowing during step iii as a result of being elongate, entangled, stitched and/or woven, or any combination thereof, and wherein at least some of those elongate, entangled, stitched or woven fibres have a length of at least 25 mm, or at least 50 mm.

35. A method according to claim 1 wherein the mould tool has a moulding surface with a three-dimensional shape and in step i the central layer portion is draped onto the moulding surface to assume the three-dimensional shape.

36. A method according to claim 35 wherein the moulding surface defines a panel shape and the moulded part is in the form of a laminated panel, or an automotive body panel.

37.-64. (canceled)
